(19) United States
(12) Patent Application Publication
(10) Pub. No.: US 2007/0154353 A1
(43) Pub. Date: Jul. 5, 2007

(54) Sensor element having an anti-fouling material in a smooth surface

(75) Inventors: Thomas Owen Mitchell, Fort Collins, CO (US); Jeff Baker, Weddington, NC (US)

Correspondence Address: THE OLLILA LAW GROUP LLC, 2060 BROADWAY, SUITE 300, BOULDER, CO, 80302, US

(73) Assignee: HACH COMPANY

(21) Appl. No.: 11/324,670

(22) Filed: Jan. 3, 2006

(51) Int. Cl. G01N 21/64

(52) U.S. Cl. 422/82.08

(57) ABSTRACT

A sensor window for a luminescent dissolved oxygen sensor with a smooth top surface having an integrated growth inhibitor is disclosed. The growth inhibiter only covers a percentage of the area of the sensor window to allow fluid to penetrate the surface of the sensor window.

### BACKGROUND OF THE INVENTION

1. Field of the Invention

The invention is related to the field of sensors, and in particular, to a luminescent dissolved oxygen sensor having a smooth sensor surface with an integrated anti-fouling material.

2. Statement of the Problem

The concentration of oxygen in water can be measured with a probe. The oxygen in the water interacts with a luminescent material on the outside of the probe. This interaction between the oxygen and the luminescent material results in a phenomenon known as luminescent quenching. Thus, the amount of luminescent quenching indicates the concentration of oxygen in the water.

In operation, the probe directs a light source centered at one wavelength onto the luminescent material. The light causes the luminescent material to generate luminescent light centered at a different wavelength. Luminescence quenching affects the amount of time that the luminescent material continues to luminescence light. Thus, if the light source's signal varies sinusoidally, the luminescence quenching affects the phase shift between the excitation light and the luminescent light. The probe uses an optical sensor to measures the phase shift between the excitation light and the luminescent light to assess the amount of luminescent quenching. As a result, the probe processes the phase shift to determine the concentration of oxygen in the water. An example of such a probe is disclosed in U.S. Pat. No. 6,912,050 entitled “Phase shift measurement for luminescent light” filed Feb. 3, 2003, which is hereby incorporated by reference.

Luminescent dissolved oxygen sensors (also called probes) are immersed in water during use. The luminescent material must be exposed to the water for the sensor to operate properly. The surface of the sensor exposed to the water may become fouled over time by biological growth or sediment. The fouled sensor may have reduced response time, inaccurate performance, or both. Many sensors have a wiper configured to clean the surface of the sensor. Some sensors may also attach a growth inhibitor to the sensor surface, for example copper. Growth inhibiters are also known as anti-fouling compounds or agents. Another example of an anti-fouling agent is material 4,5-Dichloro-2-n-octyl-4-isothiazolin-3-one (CAS registry number: 64359-81-5) manufactured by Rohm and Haas Biocides and marketed as Kathon RH-287 Microbicide. The growth inhibitor can not completely cover the sensor area, as this would create a water tight seal over the luminescent material and prevent the sensor from operating. Therefore the growth inhibiter is typically installed as a mesh or screen attached over the sensor surface. Adding a mesh or grid of growth inhibitor over the sensor surface creates pockets in the sensor surface. These pockets make it difficult to wipe the sensor clean with the wiper.

Therefore there is a need for a system and method for adding a growth inhibitor to a sensor surface without degrading the wiper performance.

### SUMMARY OF THE INVENTION

A sensor window for a luminescent dissolved oxygen sensor with a smooth top surface having an integrated growth inhibitor is disclosed. The growth inhibiter only covers a percentage of the area of the sensor window to allow fluid to penetrate the surface of the sensor window.

### BRIEF DESCRIPTION OF THE DRAWINGS

FIG. 1 is an exploded view of luminescent dissolved oxygen sensor 100.

FIG. 2 is a cross-sectional side view of a probe 200.

FIG. 3 is a cross-sectional view of a side viewing luminescent dissolved oxygen sensor 300.

FIG. 4 is an isometric view of sensor window 430.

FIG. 5a is a top view of a sheet of growth inhibiter with a pattern of openings formed into the sheet in one example embodiment of the invention.

FIG. 5b is a top view of a sheet of growth inhibiter with a pattern of openings formed into the sheet in another example embodiment of the invention.

FIG. 5c is a top view of a wire mesh of growth inhibiter an example embodiment of the invention.

FIG. 6 is a cross-sectional view of the sensor cap of a luminescent dissolved oxygen sensor in an example embodiment of the invention.

FIG. 7 is a cross-sectional view of the sensor window of a luminescent dissolved oxygen sensor in an example embodiment of the invention.

FIG. 8 is a cross-sectional view of a sensor window using a mix of anti-fouling particles and the optically opaque hydrostatically transparent material, in an example embodiment of the invention.

FIG. 9 is a cross-sectional view of a sensor window, in an example embodiment of the invention.

### DETAILED DESCRIPTION OF THE PREFERRED EMBODIMENT

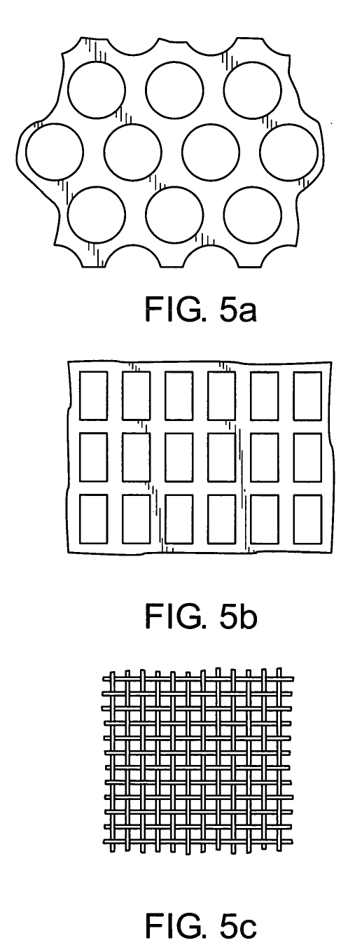

FIGS. 5-9 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

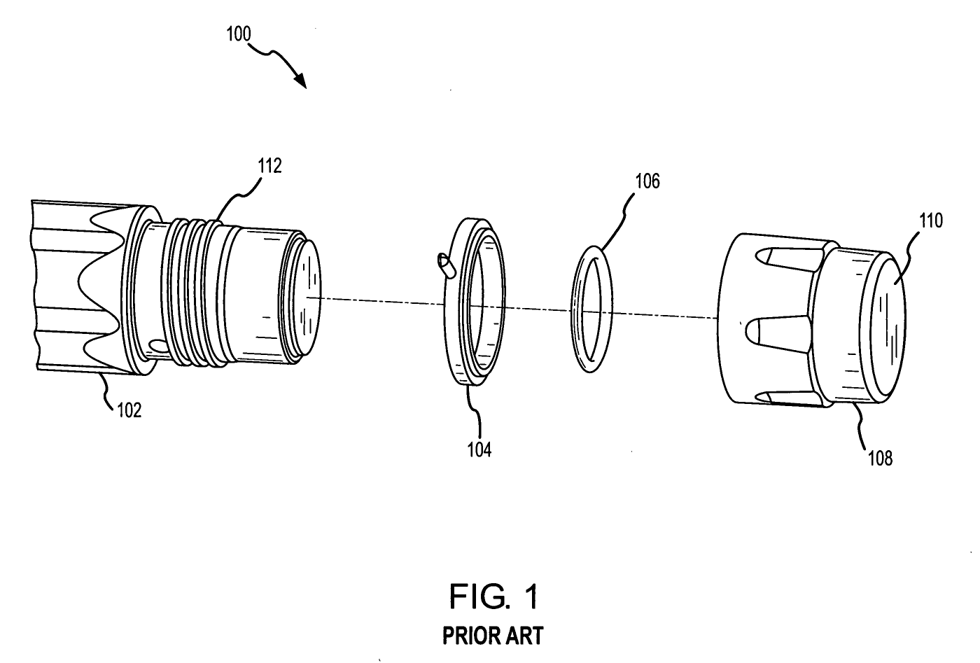

FIG. 1 is an exploded view of luminescent dissolved oxygen sensor 100. Luminescent dissolved oxygen sensor 100 comprises probe body 102, cap 108, O-ring 106, and seal 104. Cap 108 has a luminescent material deposited on face 110. Luminescent material 112 is typically a mix of Polystyrene and Platinum Porphynin. The luminescent material is covered by an optically opaque hydrostatically transparent material that allows water to penetrate to the luminescent material but prevents light from penetrating to the luminescent material. One example of an optically opaque hydrostatically transparent material is a mix of carbon lamp black and Polybutyl Methacrylate. Cap 108 is configured to screw onto threads 112 on probe body 102. O-ring 106 and seal 104 help form a water tight seal between cap 108 and body 102. Cap 108 is designed to be field replaceable. A user can remove the probe from the water, remove the fouled cap from the probe and replace it with a new cap, then re-install the probe back into the water. Face 110 is flat and a wiper mounted on an adjacent sensor (not shown) may be configured to clean face 110. In other designs, the wiper may be mounted on the same probe. Face 110 is the top side of the area of the cap that forms the sensor window. The sensor window allows light to penetrate through the hydrostatic barrier to the luminescent material from one side and allows fluid to penetrate to the luminescent material from the other side of the sensor window.

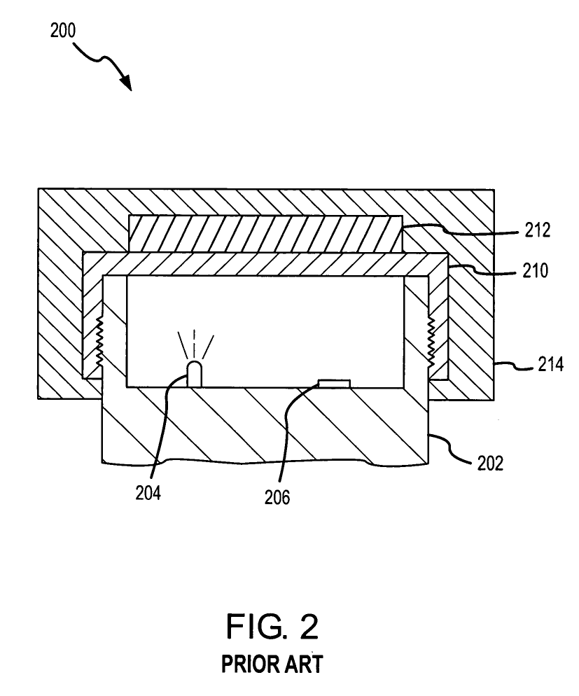

FIG. 2 is a cross-sectional side view of a probe. Probe 200 comprises probe body 202, light source 204, optical detector/sensor 206, hydrostatic barrier 210, luminescent material 212, and optically opaque hydrostatically transparent material 214.

Body 202 contains light source 204 and optical detector/sensor 206 as well as electronics (not shown) used to drive the light source and the optical detector 206. Light source 204, optical sensor 106, and electronics typically need to be kept dry. A hydrostatic barrier 210 forms a seal against body 202 to prevent fluids from entering the cavity formed by body 202. An O-ring or gasket (not shown) may be used to help form the seal between the hydrostatic barrier 210 and the body 202. The hydrostatic barrier 210 can be made from any material that is optically transparent and hydrostatically opaque, for example plastic, glass, crystal, or the like. The hydrostatic barrier is shaped as a cap that screws onto body 202. The luminescent material 212 is placed on top of the hydrostatic barrier 210. An optically opaque hydrostatically transparent 214 material is placed on top of the luminescent material 212 and surrounds hydrostatic barrier 210. The body 202 and the optically opaque hydrostatically transparent material 214 form a light tight container around light source 204, optical detector 206, and luminescent material 212. The smooth top of the cap is configured to be cleaned by a wiper.

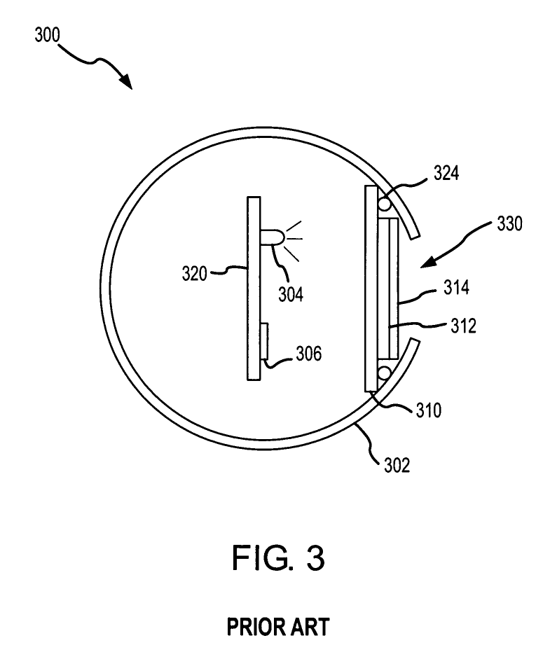

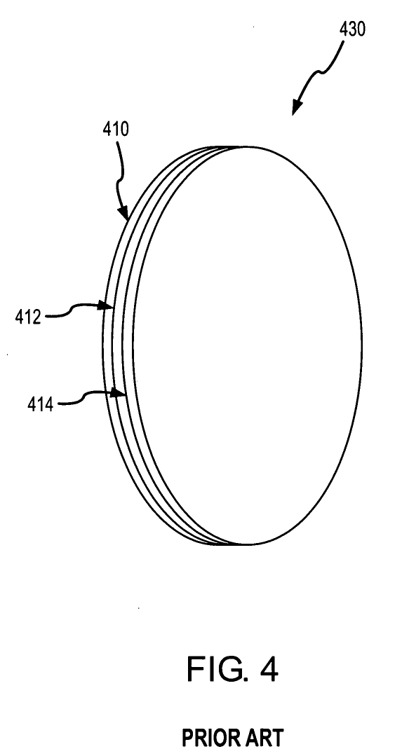

The sensor window of a luminescent dissolved oxygen sensor need not be on the top of the probe. FIG. 3 is a cross-sectional view of a side viewing luminescent dissolved oxygen sensor 300. Sensor 300 has sensor window 330 comprising a hydrostatic barrier 310, a luminescent material 312, and an optically opaque hydrostatically transparent material 314 covering the luminescent material 312. FIG. 4 is an isometric view of sensor window 430 having hydrostatic barrier 410, a luminescent material 412, and an optically opaque hydrostatically transparent material 414. The sensor window does not need to be in the shape of a circle, other shapes may be used, for example a rectangle. The drawings are not to scale and some thicknesses have been increased for clarity in explaining the invention, for example, in practice the optically opaque hydrostatically transparent material may be a thin layer (10-20 microns) deposited over the other layers. Thicker layers of the optically opaque hydrostatically transparent material may also be used.

In one example embodiment of the current invention, an anti-fouling compound is integrated into the sensor area of a luminescent dissolved oxygen sensor. The anti-fouling compound or growth inhibiter is integrated into the sensor window in such a way that the surface of the sensor window remains smooth. The smooth surface of the sensor window enables the surface of the sensor window to be easily cleaned. The anti-fouling agent can not form a water tight seal over the top of the sensor window, as this would prevent proper operation of the sensor. The type of anti-fouling agent is not important and can be copper, 4,5-Dichloro-2-n-octyl-4-isothiazolin-3-one, or the like.

In one example embodiment of the invention, the growth inhibiter may take the form of a plain with a plurality of opening formed into the plain. FIG. 5a and 5b are top views of a sheet of growth inhibiter with a pattern of openings formed into the sheet in one example embodiment of the invention. The shape of the openings is un-important and can take any shape. FIG. 5a shows the openings as circles and FIG. 5b shows the openings as squares. The size of the openings can very and can be used to control the percentage of area covered by the anti-fouling material. In one example embodiment of the invention, the percentage of the sensor window covered by the growth inhibiter can very between 10% and 80%. In another example embodiment of the invention, the anti-fouling material may take the form of a wire mesh. FIG. 5c is a top view of a growth inhibiter in the form of a wire mesh in an example embodiment of the invention.

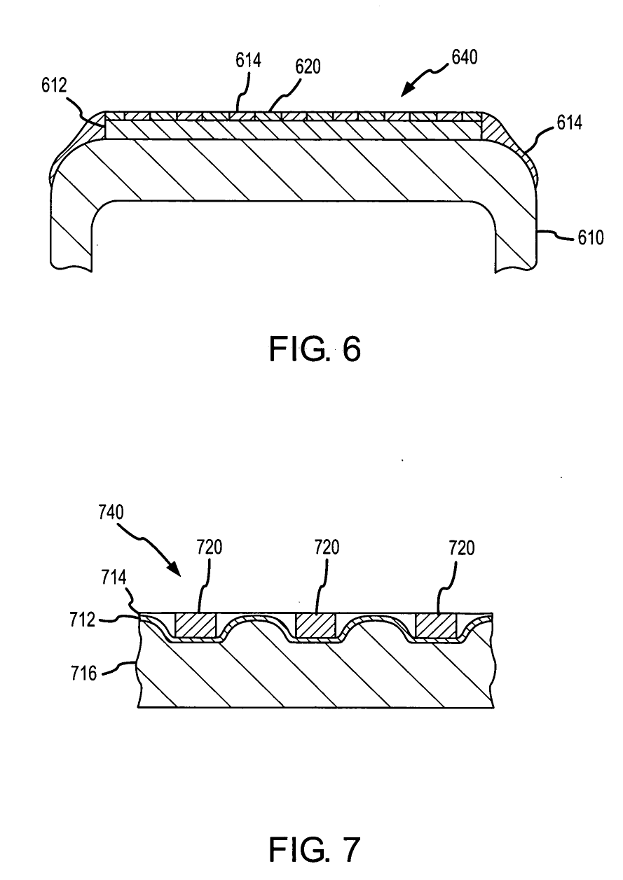

FIG. 6 is a cross-sectional view of the sensor cap of a luminescent dissolved oxygen sensor in an example embodiment of the invention. The sensor cap is comprised of hydrostatic barrier 610, luminescent material 612, optically opaque hydrostatically transparent material 614, and growth inhibiter 620. Hydrostatic barrier 610 forms a flat sensor area 640 on the top of the hydrostatic barrier 610. The luminescent material 612 forms a layer on top of the sensor area 640 of the hydrostatic barrier 610. The growth inhibiter 620 forms a layer on top of the luminescent material 612, covering only a percentage of the luminescent material 612. The growth inhibiter may extend beyond the edge of the sensor area (not shown). The optically opaque hydrostatically transparent material 614 forms a layer on top of the luminescent material 612 in the areas not covered by the growth inhibiter 620. The thickness of the optically opaque hydrostatically transparent material 614 and the growth inhibiter are adjusted such that the top surface of the sensor area 640 is essentially smooth. The smooth surface prevents growth or sediment from accumulating in pockets or depressions in the surface of the sensor window when the sensor window is wiped clean. In another example embodiment of the invention, the optically opaque hydrostatically transparent material may form a layer underneath the growth inhibiter, as well as being on the side of the growth inhibiter (not shown).

In some cases the anti-fouling material may be thicker than the nominal thickness of the optically opaque hydrostatically transparent material. FIG. 7 is a cross-sectional view of the sensor window of a luminescent dissolved oxygen sensor in an example embodiment of the invention. Sensor window comprises hydrostatic barrier 710, luminescent material 712, optically opaque hydrostatically transparent material 614, and anti-fouling material 720. In this example embodiment, anti-fouling material 720 is generally thicker than the nominal thickness of the optically opaque hydrostatically transparent material 614. To compensate for the difference in thickness, the surface of the hydrostatic barrier 710 has been formed with a non-smooth surface. The non-smooth top surface has a pattern of impressions that match the shape of the anti-fouling material. The anti-fouling material is fitted into the impressions during the manufacturing process. The anti-fouling material may also extend beyond the edge of the sensor area (not shown). The optically opaque hydrostatically transparent material 614 covers the tops of the non-smooth sensor area forming a smooth top surface 740 with the anti-fouling material.

The anti-fouling material may be integrated onto the sensor area with the optically opaque hydrostatically transparent material using a number of different manufacturing techniques. In one example embodiment of the invention the anti-fouling material is fabricated as thin sheets or as a wire mesh that is placed on top of the luminescent material. The optically opaque hydrostatically transparent material is applied and then the surface is ground, polished or wiped smooth. In another example embodiment of the invention, the growth inhibiter may be sprayed or deposited onto the sensor area. When the growth inhibiter is metallic, like copper, an electro-chemical deposition method may be used. Vacuum deposition is also possible. In another example embodiment of the invention, a mix of the optically opaque hydrostatically transparent material and particles of the anti-fouling material may applied onto the luminescent material. The top surface can then be smoothed, exposing the anti-fouling particles.

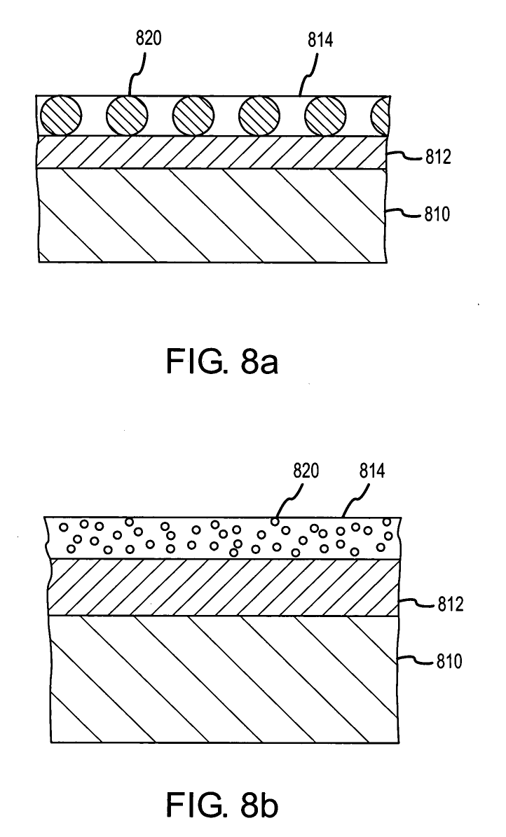

FIG. 8 is a cross-sectional view of a sensor window using a mix of anti-fouling particles and the optically opaque hydrostatically transparent material, in an example embodiment of the invention. The sensor window in FIG. 8a comprises hydrostatic barrier 810, luminescent material 812, and a layer containing an optically opaque hydrostatically transparent material 814 mixed with anti-fouling particles 820. The top surface of the mixed layer has been smoothed to expose part of the anti-fouling particles 820. The size of the anti-fouling particles 820, the number of anti-fouling particles 820 and the amount of material removed during the smoothing process, can be used to determine the ratio of anti-fouling particles and optically opaque hydrostatically transparent material exposed on the top surface of the sensor area. In one example embodiment of the invention, the particle size is smaller than the thickness of the mixed layer. FIG. 8b is a cross-sectional view of a sensor window using a mix of anti-fouling particles and the optically opaque hydrostatically transparent material, in another example embodiment of the invention. The sensor window in FIG. 8b comprises hydrostatic barrier 810, luminescent material 812, and a layer containing an optically opaque hydrostatically transparent material 814 mixed with anti-fouling particles 820. The top surface of the mixed layer has been smoothed to expose part of the anti-fouling particles 820. The anti-fouling particles are smaller in size than the thickness of the layer that contains the particles.

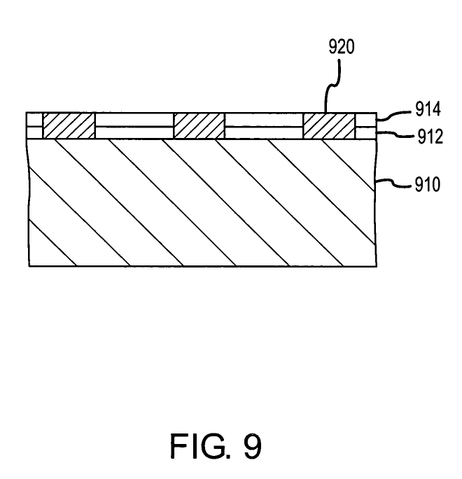

FIG. 9 is a cross-sectional view of a sensor window, in an example embodiment of the invention. The sensor window in FIG. 9 comprises hydrostatic barrier 910, luminescent material 912, optically opaque hydrostatically transparent material 914 and growth inhibiter 920. In this example embodiment, growth inhibiter is on top of, and covers a percentage of, hydrostatic barrier 910. Luminescent material 912 also forms a layer on top of hydrostatic barrier 910, covering the part of hydrostatic barrier 910 left exposed by the openings in growth inhibiter 920. Optically opaque hydrostatically transparent material 914 forms a layer on top of the luminescent material 912. The thicknesses of the optically opaque hydrostatically transparent material 914 and the luminescent material 912 are adjusted to match the thickness of the growth inhibiter, thereby forming a smooth top surface for the sensor window.

In the examples of the sensor window describe above, the sensor window was flat as well as smooth. This invention is not limited to flat sensor windows, other shapes may also be used, for example cylindrical shapes or toroid shapes.

We claim:

1. A luminescent dissolved oxygen sensor, comprising:
a sensor window with a smooth top surface, the smooth top surface having an area;
a growth inhibiter forming a first percentage X of the area;
an optically opaque hydrostatically transparent material forming a second percentage Y of the area.

2. The luminescent dissolved oxygen sensor of claim 1 where the growth inhibiter is copper.

3. The luminescent dissolved oxygen sensor of claim 1 where the first percentage X is between 10% and 80%.

4. The luminescent dissolved oxygen sensor of claim 1 where Y is approximately equal to 100%-X.

5. The luminescent dissolved oxygen sensor of claim 1 where the growth inhibiter is in the form of particles mixed with the optically opaque hydrostatically transparent material.

6. The luminescent dissolved oxygen sensor of claim 5 where the particles of growth inhibiter have a size that is smaller than a thickness of a layer formed by the mixed optically opaque hydrostatically transparent material and growth inhibiter.

7. The luminescent dissolved oxygen sensor of claim 1 further comprising:
a luminescent material forming a layer underneath the optically opaque hydrostatically transparent material.

8. The luminescent dissolved oxygen sensor of claim 7 where the growth inhibiter has a first thickness and the optically opaque hydrostatically transparent material has a second thickness and the layer of luminescent material has a third thickness and where the first thickness is equal to the second thickness plus the third thickness.

9. The luminescent dissolved oxygen sensor of claim 7 where the growth inhibiter has a first thickness and the optically opaque hydrostatically transparent material has a second thickness and the layer of luminescent material has a third thickness and where the first thickness is larger than the second thickness plus the third thickness.

10. The luminescent dissolved oxygen sensor of claim 7 further comprising:
a hydrostatic barrier forming a layer underneath the growth inhibiter and the luminescent material.

11. The luminescent dissolved oxygen sensor of claim 7 where the luminescent material also forms a layer underneath the growth inhibiter.

12. The luminescent dissolved oxygen sensor of claim 11 where the growth inhibiter has a first thickness and the optically opaque hydrostatically transparent material has a second thickness and where the first thickness is equal to the second thickness.

13. The luminescent dissolved oxygen sensor of claim 11 where the growth inhibiter has a first thickness and the optically opaque hydrostatically transparent material has a second thickness and where the first thickness is larger than the second thickness.

14. The luminescent dissolved oxygen sensor of claim 11 further comprising:
a hydrostatic barrier forming a layer underneath the luminescent material.

15. The luminescent dissolved oxygen sensor of claim 1 where the growth inhibiter is in the form of a solid surface with a plurality of openings distributed across the solid surface and where the optically opaque hydrostatically transparent material fills the plurality of openings.

16. The luminescent dissolved oxygen sensor of claim 1 where the plurality of openings are circular in shape.

17. A method, comprising:
covering a part of an area of a sensor window with an anti-fouling material;
covering the part of the sensor window not covered by the anti-fouling material with an optically opaque hydrostatically transparent material;
smoothing the surface formed by the anti-fouling material and the optically opaque hydrostatically transparent material.

18. A method, comprising:
depositing a layer of luminescent material onto a hydrostatic barrier;
covering a first percentage of the luminescent material with an anti-fouling material thereby leaving a second percentage of the luminescent material exposed;
covering the exposed luminescent material with an optically opaque hydrostatically transparent material;
smoothing the surface formed by the anti-fouling material and the optically opaque hydrostatically transparent material.

19. A method, comprising:
mixing particles of an anti-fouling compound into an optically opaque hydrostatically transparent material;
covering a luminescent material with a layer of the optically opaque hydrostatically transparent material and anti-fouling particle mix;
smoothing the surface of the layer.
